(19) United States
(12) Patent Application Publication
(10) Pub. No.: US 2013/0148596 A1
(43) Pub. Date: Jun. 13, 2013

(54) RESOURCE MANAGEMENT SYSTEM AND METHOD OF CENTRALIZED BASE STATION IN MOBILE COMMUNICATION NETWORK

(71) Applicant: Electronics and Telecommunications Research In, Daejeon (KR)

(72) Inventors: Yeon Seung SHIN, Daejeon (KR); Jee Hyeon NA, Daejeon (KR); Woo Goo PARK, Daejeon (KR); Nam Hoon PARK, Daejeon (KR)

(73) Assignee: Electronics and Telecommunications Research Institute, Daejeon (KR)

(21) Appl. No.: 13/705,530

(22) Filed: Dec. 5, 2012

(30) Foreign Application Priority Data
Dec. 9, 2011 (KR) 10-2011-0131698

(51) Int. Cl. H04W 72/04

(52) U.S. Cl. CPC H04W 72/04
USPC 370/329

(57) ABSTRACT

A resource management system and method of a centralized base station in a mobile communication network are provided. The resource management system of the network communication separates a radio unit (RU) and a digital unit (DU) which are combined in the related art to thereby enable the RU and DU to be interlocked via an optical cable, installs each RU in a service area connected with terminals with respect to a plurality of base stations, and installs the integrated DUs in a single large system to thereby operate the DUs as an integrated base station, and therefore it is possible to effectively use DU resources, which are distributed and operated, through integrated management.

### CLAIM FOR PRIORITY

This application claims priority to Korean Patent Application No. 10-2011-0131698 filed on Dec. 9, 2011 in the Korean Intellectual Property Office (KIPO), the entire contents of which are hereby incorporated by reference.

### BACKGROUND

1. Technical Field

Example embodiments of the present invention relate in general to a resource management system and method of a centralized base station in a mobile communication network and more specifically to a resource management system and method of a centralized base station in a mobile communication network using the centralized base station.

2. Related Art

A base station used in a mobile communication network in the conventional art includes radio unit (RU) resources that are responsible for radio waves and digital unit (DU) resources that are responsible for digital data processing of transmitted and received radio waves. In general, the DU resources of the base station are designed and operated based on the case of the maximum traffic so as to provide stable performance of the mobile communication network. However, the maximum performance is not always required to process the traffic in the base station, but is required only at a specific time, and therefore there is a problem such as a waste of the DU resources in the base station designed in the above-described standard.

In addition, in the morning or evening hours, large amounts of traffic are generated in base stations located in residential areas, while relatively small amounts of traffic are generated in base stations located in commercial areas. During the day, smaller amounts of traffic are generated in base stations located in residential areas, while relatively large amounts of traffic are generated in base stations located in commercial areas. In such cases, in order to obtain stable performance of a mobile communication network, more DU resources should be allocated to base stations located in residential areas in the morning or evening hours, and more DU resources should be allocated to base stations located in commercial areas during the day. However, in a conventional mobile communication network, an allocation amount of DU resources cannot be flexibly adjusted, and therefore it is difficult to obtain stable performance of the mobile communication network.

### SUMMARY

Accordingly, example embodiments of the present invention are provided to substantially obviate one or more problems due to limitations and disadvantages of the related art.

Example embodiments of the present invention provide a resource management system of a communication network that flexibly adjusts an allocation amount of digital unit (DU) resources in accordance with traffic.

Example embodiments of the present invention also provide a resource management method of a communication network that flexibly adjusts an allocation amount of DU resources in accordance with traffic.

A base station interlocked with a resource management system of a communication network according to an embodiment of the present invention is as follows.

The conventional base station in which radio unit (RU) resources that are responsible for radio waves and DU resources that are responsible for digital data processing of transmitted and received radio waves are combined is installed in a position of a service area, but in a base station according to the embodiments of the present invention, the RU resources and the DU resources are separated and installed in each service area in the same manner as that in the conventional art, and all DU resources are integrated in a single integrated base station (DU center) regardless of the service area to thereby be managed. The integrated base station (DU center) may integrate and manage at least two to twenty DU resources, and the RU resources and the DU resources may be connected to each other via an optical cable. In this instance, the RU resources and the DU resources may be positioned to be spaced apart from each other by at least 20 km through the optical cable.

The integrated base station (DU center) may effectively manage the DU resources of the integrated base station through allocation of idle DU resources for a request for the DU resources according to an increase in traffic and recovery of the DU resources according to a reduction in the traffic by integrating and managing DU resources which are distributed and operated in each base station in a single large system.

In addition, the integrated base station may include a resource management apparatus that receives DU resource information from a neighboring integrated base station which is connected with the integrated base station, and allocates idle DU resources to the base station connected with the integrated base station based on state information of the received DU resources or receives the DU resources allocated to the base station connected with the integrated base station.

In some example embodiments, a resource management method of a communication network, which is performed in an integrated base station, includes: requesting, from a resource management apparatus, allocation of idle DU resources for another wireless connection technology when receiving a request for use of the other wireless connection technology other than wireless connection technology using allocated DU resources; receiving, from the resource management apparatus, an idle DU resource list in response to the request for the allocation of the idle DU resources; receiving, from the resource management apparatus, software associated with the other wireless connection technology to be used in the idle DU resources included in the idle DU resource list; and constructing a data processing environment of corresponding wireless connection technology using the idle DU resources included in the idle UD resource list and the software, and processing data through the constructed data processing environment.

In this instance, receiving the software may include receiving, from the resource management apparatus, the software associated with the other wireless connection technology to be used in the idle DU resources included in the idle DU resource list when the idle DU resources included in the idle DU resource list received from the resource management apparatus are available.

In addition, constructing and processing may include setting a session by constructing the data processing environment of the corresponding wireless connection technology using the idle DU resources and the software, performing a test on the constructed environment through the session, and processing actual data through the session when the test through the session succeeds.

In other example embodiments, a resource management method of a communication network, which is performed in an integrated base station, includes: monitoring traffic through wireless connection technology using allocated DU resources; requesting allocation of idle DU resources for arbitrary wireless connection technology when traffic through the arbitrary wireless connection technology from among the wireless connection technology using the allocated DU resources is an allocation reference or larger as determined from the monitoring; receiving, from a resource management apparatus, an idle DU resource list in response to the request for the allocation of the idle DU resources; receiving, from the resource management apparatus, software associated with the arbitrary wireless connection technology to use the idle DU resources included in the idle DU resource list; and constructing a data processing environment of corresponding wireless connection technology using the idle DU resources included in the idle DU resource list and the software, and processing data through the constructed data processing environment.

In this instance, receiving the software may include receiving, from the resource management apparatus, the software associated with the arbitrary wireless connection technology to use the idle DU resources included in the idle DU resource list when the idle DU resources included in the idle DU resource list received from the resource management apparatus are available.

In addition, constructing and processing may include setting a session by constructing the data processing environment of the corresponding wireless connection technology using the idle DU resources and the software, performing a test on the constructed environment through the session, and processing actual data through the session when the test through the session succeeds.

Here, the resource management method may further include requesting the return of the allocated DU resources for the arbitrary wireless connection technology when the traffic through the arbitrary wireless connection technology from among the wireless connection technology using the allocated DU resources is a return standard or less based on the result of the monitoring; and receiving, from the resource management apparatus, a return DU resource list in response to the request for the return of the allocated DU resources; and returning, to the resource management apparatus, return DU resources by deleting corresponding software from the return DU resources included in the return DU resource list.

In addition, returning may include determining whether processing of data is performed through the return DU resources included in the return DU resource list; moving the data processed through the return DU resources included in the return DU resource list so as to enable the data to be processed through other DU resources in the same integrated base station so that the processing of data is not performed through the return DU resources included in the return DU resource list, when the processing of data is determined to be performed through the return DU resources included in the return DU resource list; deleting software installed in the return DU resources included in the return DU resource list; and notifying the resource management apparatus that a return process of the return DU resources included in the return DU resource list is completed.

In still other example embodiments, a resource management method of a communication network, which is performed in a resource management apparatus, includes: receiving DU resource information from at least one integrated base station, and dynamically managing a state of the use of a DU resource a basis of the DU resource information; receiving a request for allocation of idle DU resources from an arbitrary integrated base station from among the at least one integrated base station; generating an idle DU resource list by designating the idle DU resources based on an allocation reference of the DU resources according a traffic performance for each wireless connection technology in response to the request for the allocation of the idle DU resources, and providing the generated idle DU resource list to the arbitrary integrated base station; and providing corresponding software to the arbitrary integrated base station in response to a request for provision of software associated with the wireless connection technology to be used in the idle DU resources included in the idle DU resource list.

Here, the resource management method may further include: receiving a request for return of the allocated DU resources from the arbitrary integrated base station among the at least one integrated base station; and generating a return DU resource list using DU resources required for currently processing traffic in the arbitrary integrated base station and the DU resources allocated to the arbitrary integrated base station in response to the request for the return of the allocated DU resources, and providing the generated return DU resource list to the arbitrary integrated base station.

### BRIEF DESCRIPTION OF DRAWINGS

Example embodiments of the present invention will become more apparent by describing in detail example embodiments of the present invention with reference to the accompanying drawings, in which:

FIG. 1 is a block diagram illustrating a configuration of a resource management system of a communication network according to an embodiment of the present invention;

FIG. 2 is a conceptual diagram illustrating a configuration of DU resources (HW resources) included in an integrated base station;

FIG. 3 is a drawing illustrating an allocation reference of DU resources according to traffic processing performance for each wireless connection technology;

FIG. 4 is a drawing illustrating real-time state information of DU resources managed in a resource management apparatus;

FIG. 5 is a flowchart illustrating a resource management method of a communication network according to an embodiment of the present invention;

FIGS. 6 and 7 are flowcharts illustrating a resource management method of a communication network according to another embodiment of the present invention; and

FIG. 8 is a flowchart illustrating a resource management method of a communication network according to still another embodiment of the present invention.

### DESCRIPTION OF EXAMPLE EMBODIMENTS

Example embodiments of the present invention are disclosed herein. However, specific structural and functional details disclosed herein are merely representative for purposes of describing example embodiments of the present invention, however, example embodiments of the present invention may be embodied in many alternate forms and should not be construed as limited to example embodiments of the present invention set forth herein.

Accordingly, while the invention is susceptible to various modifications and alternative forms, specific embodiments thereof are shown by way of example in the drawings and will herein be described in detail. It should be understood, however, that there is no intent to limit the invention to the particular forms disclosed, but on the contrary, the invention is to cover all modifications, equivalents, and alternatives falling within the spirit and scope of the invention. Like numbers refer to like elements throughout the description of the figures.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of the present invention. As used herein, the term “and/or” includes any and all combinations of one or more of the associated listed items.

It will be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present. Other words used to describe the relationship between elements should be interpreted in a like fashion (i.e., “between” versus “directly between,” “adjacent” versus “directly adjacent,” etc.).

The terminology used herein is for the purpose of describing particular embodiments only and is not intended to be limiting of the invention. As used herein, the singular forms “a,” “an” and “the” are intended to include the plural forms as well, unless the context clearly indicates otherwise. It will be further understood that the terms “comprises,” “comprising,” “includes” and/or “including,” when used herein, specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

It should also be noted that in some alternative implementations, the functions/acts noted in the blocks may occur out of the order noted in the flowcharts. For example, two blocks shown in succession may in fact be executed substantially concurrently or the blocks may sometimes be executed in the reverse order, depending upon the functionality/acts involved.

In the present invention, a resource management server or the like may be used as a resource management apparatus, and the resource management server denotes the resource management apparatus throughout the specification.

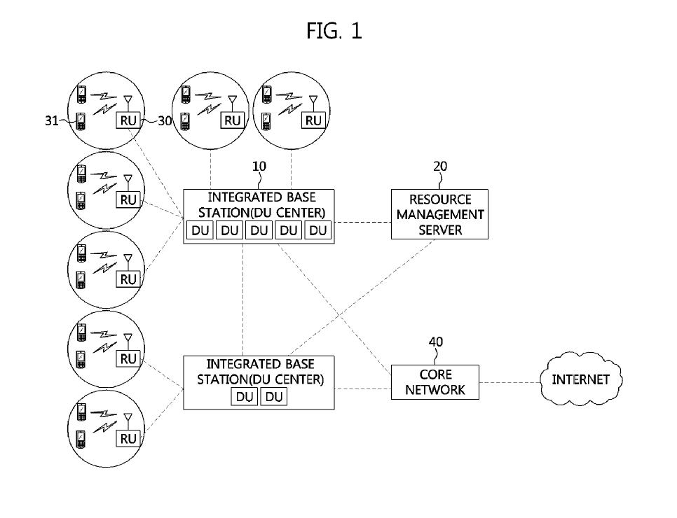

FIG. 1 is a block diagram illustrating a configuration of a resource management system of a communication network according to an embodiment of the present invention. Here, the resource management system may include an integrated base station 10 (DU center), or include the integrated base station 10 and a resource management server 20 (here, the resource management server denotes the resource management apparatus).

Referring to FIG. 1, a mobile communication network includes a radio unit (RU) 30 connected with a terminal 31, the integrated base station 10 connected with at least one RU 30, the resource management server 20 connected with at least one integrated base station 10, and a core network 40 connected with at least one integrated base station 10. A single integrated base station 10 may be connected with another integrated base station 10, and the RU 30, the integrated base station 10, and the resource management server 20 may be connected to each other in a wired manner.

The integrated base station 10 may include at least one digital unit (DU) and a control unit (not shown), and the control unit may perform functions such as an allocation request of idle DU resources, a return request of the allocated DU resources, data processing based on the DU resources, and the like. The resource management apparatus 20 may include a storage unit (not shown) and a management unit (not shown). Here, the storage unit receives DU resource information and stores the received information, and the management unit performs functions such as allocation of the idle DU resources, return of the allocated DU resources, and the like.

The integrated base station 10 includes at least one DU resource, and requests, from the resource management server 20, allocation of the DU resources which are idle according to a request for improvement of traffic processing performance of wireless connection technology to be currently used and a request for improvement of traffic processing performance of wireless connection technology to be newly used. That is, when use of new wireless connection technology is requested by the integrated base station 10, or when a sharp increase in traffic is expected in the wireless connection technology to be currently used, additional DU resources other than the new DU resources or existing DU resources are required, and therefore the integrated base station 10 requests allocation of the idle DU resources from the resource management server 20. In addition, when the DU resources are wasted due to a reduction in the traffic from among the allocated DU resources, the integrated base station 10 requests return of the wasted DU resources from the resource management server 20.

In addition, the DU resources constituting the integrated base station 10 may include digital signal processing (DSP)-core resources, general purpose preprocessor (GPP)-core resources, switch resources, and the like.

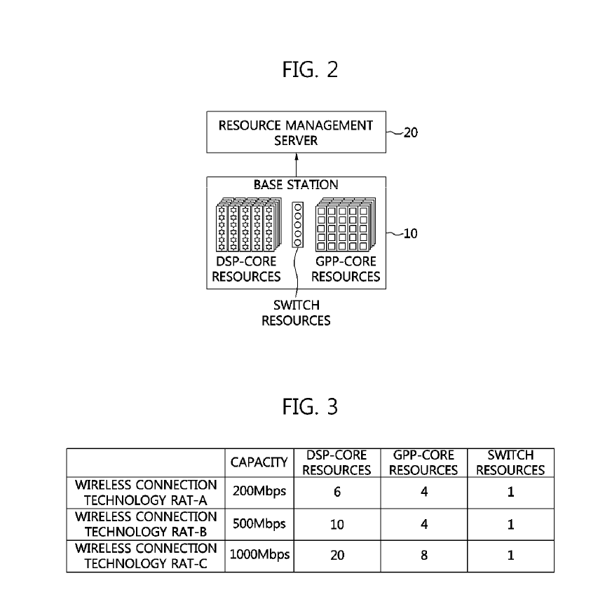

FIG. 2 is a conceptual diagram illustrating a configuration of DU resources (HW resources) included in an integrated base station. Referring to FIG. 2, the DU resources of the integrated base station 10 include five DSP-core resource blades, five GPP-core resource blades, and five switch resources.

Here, one DSP-core resource blade includes five DSP-core resources having six cores, for a total of 30 DSP-cores, and one GPP-core resource blade includes five GPP-core resources having five cores, for a total of 25 GPP-cores. That is, the DU resources of FIG. 2 include 150 DSP-cores, 125 GPP-cores, and five switch resources, and this DU resource information is registered in the resource management server 20 at the time of booting of the integrated base station 10.

In addition, the integrated base station 10 may further include a software defined radio (SDR) module, and therefore it is possible to use a variety of wireless connection technology only by a change in modulated software without a change in hardware. Here, the used wireless connection technology includes Long Term Evolution (LTE), Long Term Evolution-Advanced (LTE-A), High Speed Downlink Packet Access (HSDPA), and the like.

The resource management server 20 is connected with at least one integrated base station 10, receives the DU resource information from the connected integrated base station 10, and manages state information of the received DU resource information for each core.

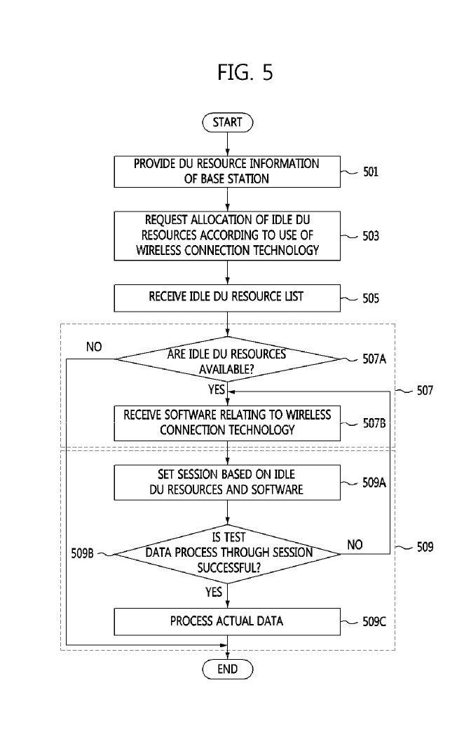

Referring to FIG. 4, the resource management server 20 manages information such as a status (not_used or used), an address, a location, and a location 2 of each core.

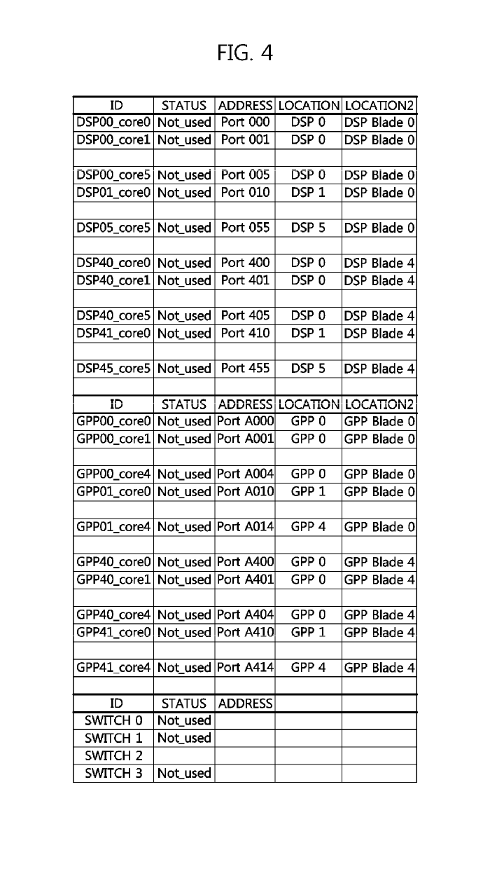

In addition, when allocation of the DU resources is requested by the integrated base station 10, the resource management server 20 detects idle DU resources based on the DU resource information to thereby allocate the detected idle DU resources to the integrated base station 10, and return of the allocated DU resources is requested by the integrated base station 10, the resource management server 20 recovers the allocated DU resources based on a DU resource allocation reference according to a current traffic amount state of the integrated base station 10 requesting the return and traffic processing performance for each wireless connection technology of FIG. 3.

In addition, in the resource management server 20, software relating to the wireless connection technology is stored, corresponding software is searched for in response to a request for provision of the software of the integrated base station 10, and the searched software is provided to the integrated base station 10. In the resource management server 20, software relating to LTE, software relating to LTE-A, software relating to HSDPA, or the like may be stored.

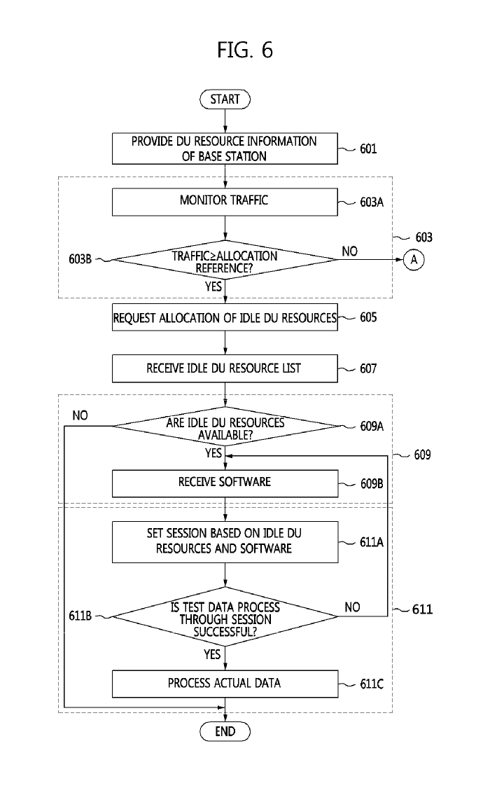

FIG. 5 is a flowchart illustrating a resource management method of a communication network according to an embodiment of the present invention.

FIG. 5 illustrates a method in which idle DU resources from the resource management server 20 are allocated to the integrated base station 10 in response to a request for the use of new wireless connection technology.

In step 501, the integrated base station 10 provides its own DU resource information to the resource management server 20 while booting. In this instance, the DU resource information provided to the resource management server 20 may include DSP-core resources, GPP-core resources, and switch resources.

In step 503, when new wireless connection technology is requested, the integrated base station 10 requests, from the resource management server 20, allocation of idle DU resources for the new wireless connection technology. Here, the used wireless connection technology may include LTE, LTE-A, HSDPA, or the like.

In step 505, the integrated base station 10 receives an idle DU resource list from the resource management server 20 in response to the request for the allocation of the idle DU resources, and the idle resource list includes addresses, locations, and the like of the idle DU resources.

In step 507, software relating to new wireless connection technology to use the idle DU resources included in the idle DU resource list is received from the resource management server 20, and step S507 includes steps 507a and 507b.

In step 507a, it is determined whether the idle DU resources included in the idle DU resource list provided from the resource management server 20 are available, and it is determined whether the new wireless connection technology can use the idle DU resources included in the idle DU resource list.

In step 507b, when the idle DU resources are determined to be available, software relating to the new wireless connection technology is provided from the resource management server 20. When the idle DU resources are determined not to be available, all steps are terminated. For example, in step 507b, when the new wireless connection technology is LTE, software relating to LTE is provided from the resource management server 20, and when the new wireless connection technology is HSDPA, software relating to HSDPA is provided from the resource management server 20.

In addition, in step 505, when the idle DU resources are determined not to be available in step 507a, a new idle DU resource list may be provided.

In step 509, data is processed by constructing a data processing environment of corresponding wireless connection technology using the idle DU resources included in the idle DU resource list and the software, and step 509 includes steps 509a, 509b, and 509c.

In step 509a, a session is set using the idle DU resources and the software. Specifically, the software is installed in the idle DU resources included in the idle DU resource list, and the session is set using the idle DU resources included in the idle DU resource list and the installed software.

In step 509b, a test (data transmission function test) is performed on the constructed environment through the session set in step 509a, and step 509c is performed or step 507b is repeatedly performed according to a result of the test. That is, when the test succeeds, improvement of traffic processing performance is verified, and actual data is processed in step 509c, and when the test fails, software relating to the wireless connection technology is repeatedly provided in step 507b.

In step 509c, when the test is determined to have succeeded in step 509b, the actual data is processed by constructing a new data processing environment using the idle DU resources included in the idle DU resource list provided from the resource management server 20 and the software.

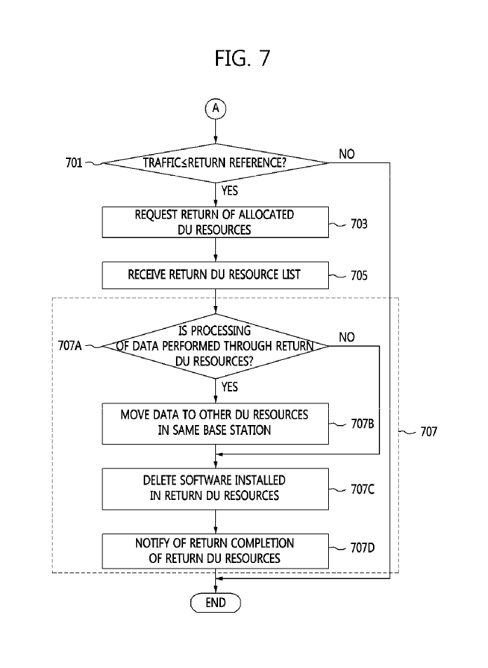

FIGS. 6 and 7 are flowcharts illustrating a resource management method of a communication network according to another embodiment of the present invention.

FIGS. 6 and 7 illustrate a method in which the idle DU resources from the resource management server 20 are allocated to the integrated base station 10, or the DU resources allocated to the resource management server 20 are returned.

In step 601, the integrated base station 10 provides its own DU resource information to the resource management server 20 while booting. In this instance, the DU resource information provided to the resource management server 20 includes DSP-core resources, GPP-core resources, and switch resources.

In step 603, traffic is monitored through wireless connection technology using the DU resources allocated from the resource management server 20. In this instance, a processing state of the traffic is monitored through each wireless connection technology using the allocated DU resources.

Specifically, in step 603a, the traffic is continuously monitored through the wireless connection technology using the allocated DU resources, and in step 603b, it is determined whether the traffic through each wireless connection technology is an allocation reference or larger based on a result of the monitoring. Here, the allocation reference is an upper reference value for stably performing traffic transmission of specific wireless connection technology in a current integrated base station 10, and for example, the allocation reference may be set as 85% of processing performance which the specific wireless connection technology can currently provide.

In step 605, when the traffic through the specific wireless connection technology is the allocation reference or larger, the integrated base station requests, from the resource management server 20, allocation of the idle DU resources according to an increase in the traffic. Here, the used wireless connection technology includes LTE, LTE-A, HSDPA, and the like.

In step 607, an idle DU resource list is provided from the resource management server 20 in response to the request for the allocation of the idle DU resources, and the idle DU resource list includes addresses, locations, or the like.

In step 609, software relating to the wireless connection technology to use the idle DU resources included in the idle DU resource list is provided from the resource management server 20, and step 609 includes steps 609a and 609b.

In step 609a, it is determined whether the idle DU resources included in the idle DU resource list provided from the resource management server 20 are available, and specifically, it is determined whether new wireless connection technology can use the idle DU resources included in the idle DU resource list.

Here, when the idle DU resources are determined to be available, software relating to the new wireless connection technology is provided from the resource management server 20 in step 609b, and when the idle DU resources are determined not to be available, all steps are terminated.

For example, in step 609b, when the new wireless connection technology is LTE, software relating to LTE is provided from the resource management server 20, and when the new wireless connection technology is HSDPA, software relating to HSDPA is provided from the resource management server 20.

In addition, in step 607, when the idle DU resources are determined not to be available in step 609a, a new idle DU resource list may be provided.

In step 611, data is processed by constructing a data processing environment of corresponding wireless connection technology using the idle DU resources included in the idle DU resource list and the software, and step 611 includes steps 611a, 611b, and 611c.

In step 611a, a session is set by constructing the data processing environment of the corresponding wireless connection technology using the idle DU resources and the software. Here, the software is installed in the idle DU resources included in the idle DU resource list, and the session is set using the installed software and the idle DU resources included in the idle DU resource list.

In step 611b, a test is performed on the constructed environment through the session set in step 611a, and step 611c is performed or step 609b is repeatedly performed according to a result of the test. That is, when the test succeeds, actual data is processed in step 611c, and when the test fails, the software relating to the wireless connection technology is repeatedly provided and re-installed in step 609b.

In step 611c, when the test is determined to have succeeded in step 611b, the actual data is processed by constructing the data processing environment using the idle DU resources included in the idle DU resource list provided from the resource management server 20 and the downloaded software.

In step 701, when a traffic transmission amount through specific wireless connection technology is less than an allocation reference, it is determined whether a traffic transmission amount using the wireless connection technology is less than a return reference of the DU resources based on a result of the monitoring in step 603a. Here, the return reference is a reference value that determines whether the DU resources are unnecessarily wasted, and for example, the return reference may be set as 50% of processing performance which specific wireless connection technology can currently provide.

When the traffic through the wireless connection technology is less than the return reference (50%) in step 701, the process proceeds to step 703, and when the traffic through the wireless connection technology exceeds the return reference, all steps are terminated.

In step 703, when the traffic through the wireless connection technology is less than the return reference, the integrated base station 10 requests, from the resource management server 20, return of the DU resources allocated to the integrated base station 10.

In step 705, a return DU resource list is provided from the resource management server 20 in response to the request for the return of the allocated DU resources.

In step 707a, it is determined whether processing of data is performed through the return DU resources included in the return DU resource list provided from the resource management server 20.

In step 707b, when the processing of data is determined to be performed through the return DU resources, the data processed through the return DU resources is moved to other DU resources in the same integrated base station 10 so that the processing of data is not performed through the return DU resources, and when the processing of data is determined not to be performed through the return DU resources, the process proceeds to step 707c.

When the data processed through the return DU resources is moved to the other DU resources in the same integrated base station 10 or when the processing of data is not performed through the return DU resources, the integrated base station 10 deletes the software relating to the wireless connection technology which is installed in the return DU resources in step 707c, and notifies the resource management server 20 that a return process of the return DU resources is completed in step 707d.

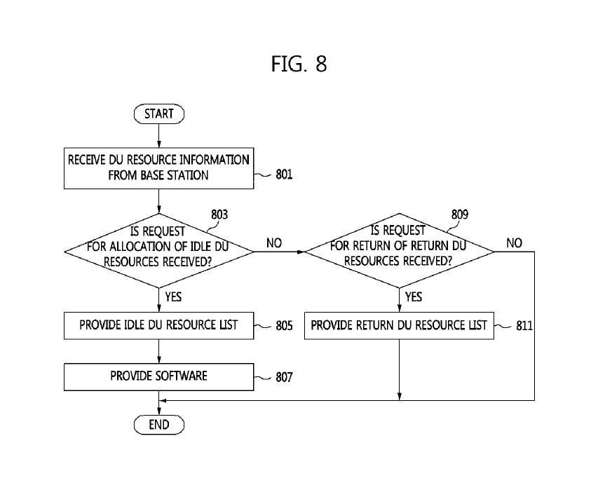

FIG. 8 is a flowchart illustrating a resource management method of a communication network according to still another embodiment of the present invention, and in FIG. 8, a method in which the resource management server 20 allocates idle DU resources to the integrated base station 10 in response to a request of the integrated base station 10, or receives return of the allocated DU resources is illustrated.

In step 801, the resource management server 20 receives DU resource information from the integrated base station 10 when the integrated base station 10 is booted, and manages the received DU resource information for each core.

Referring to FIG. 4, the resource management server 20 actively manages information such as status (not_used, used), address, location, and location 2. Here, the active management denotes changing the information such as status (not_used, used) and the like according to allocation/return of the DU resources.

In step 803, it is determined whether a request for allocation of idle DU resources is received from the integrated base station 10, and when the request for the allocation of the idle DU resources is received, the process proceeds to step 805, and when the request for the allocation of the idle DU resources is not received, the process proceeds to step 811.

The request for the allocation of the idle DU resources includes a request for allocation of the idle DU resources according to a request for use of new wireless connection technology, and a request for allocation of the idle DU resources according to an increase in traffic in the wireless connection technology to be currently used.

In step 805, an idle DU resource list is generated, and the generated idle DU resource list is provided to the integrated base station 10 that requests the allocation of the idle DU resources. In this instance, the idle DU resource list is generated based on an allocation reference of the DU resources according to the DU resource information shown in FIG. 4 and the traffic processing performance for each wireless connection technology shown in FIG. 3.

That is, the resource management server 20 that receives the request for the allocation of the idle DU resources determines the number of the resources required in a DU resource allocation reference table for each wireless connection technology according to a required traffic amount, and selects the DU resources whose status is idle (not_used) in the DU resource management information to thereby generate the idle DU resource list.

For example, when the wireless connection technology used in the integrated base station 10 requests 20 Mbps in RAT-A, the idle DU resource list is generated so that six DSP-core resources, four GPP-core resources, and one switch resource are allocated.

In step 807, when a request for provision of software is received from the integrated base station 10 which requests the allocation of the idle DU resources, corresponding software is provided to the integrated base station 10. That is, software relating to the wireless connection technology (software relating to LTE, software relating to LTE-A, software relating to HSDPA, and the like) is stored in the resource management server 20, and therefore corresponding software is searched for in response to the request for provision of software of the integrated base station 10, and the searched corresponding software is provided to the integrated base station 10.

In step 809, it is determined whether a request for return of the allocated DU resources is received from the integrated base station 10, and when the request for the return of the allocated DU resources is received, the process proceeds to step 811, and otherwise, all steps are terminated.

In step 811, a return DU resource list is generated, and the generated return DU resource list is provided to the integrated base station 10 that requests the return of the allocated DU resources. In this instance, the resource management server 20 generates the return DU resource list based on the DU resources required for currently processing data in the integrated base station 10 that requests the return of the allocated DU resources, and based on the allocation reference of the DU resources according to the traffic processing performance for each wireless connection technology shown in FIG. 3. That is, the DU resources which are currently wasted are detected through “data processing performance of allocated DU resources-processing performance required for currently processing data,” and the return DU resource list is generated with reference to the allocation reference of the DU resources of FIG. 3 based on the detected DU resources to thereby provide the generated return DU resource list to the integrated base station 20.

As described above, according to the embodiments of the invention, when traffic of the integrated base station (DU center) is increased, the integrated base station requests the idle DU resources from the resource management apparatus that manages the DU resources of the integrated base station and improves the traffic processing performance based on the allocation of the requested idle DU resources, and when the traffic of the integrated base station is reduced, the integrated base station returns the allocated DU resources to the resource management apparatus, and thereby a mobile communication service quality may be stably operated by effectively using the DU resources according to a change in the traffic without wasting the DU resources.

In addition, when the traffic generated in the integrated base station is sharply increased in an instantaneous manner, the idle DU resources that are managed by the resource management apparatus are automatically allocated and used without additionally installing the DU resources unlike the related art, and therefore it is possible to reduce costs generated by the additional installation of the DU resources.

While the example embodiments of the present invention and their advantages have been described in detail, it should be understood that various changes, substitutions and alterations may be made herein without departing from the scope of the invention.

What is claimed is:

1. A resource management method of a communication network which is performed in an integrated base station, comprising:
requesting, from a resource management apparatus, allocation of idle DU resources for another wireless connection technology when receiving a request for use of the other wireless connection technology other than wireless connection technology using allocated DU resources;
receiving, from the resource management apparatus, an idle DU resource list in response to the request for the allocation of the idle DU resources;
receiving, from the resource management apparatus, software associated with the other wireless connection technology to be used in the idle DU resources included in the idle DU resource list; and
constructing a data processing environment of corresponding wireless connection technology using the idle DU resources included in the idle UD resource list and the software, and processing data through the constructed data processing environment.

2. The resource management method of claim 1, wherein receiving the software includes receiving, from the resource management apparatus, the software associated with the other wireless connection technology to be used in the idle DU resources included in the idle DU resource list when the idle DU resources included in the idle DU resource list received from the resource management apparatus are available.

3. The resource management method of claim 1, wherein constructing and processing includes
setting a session by constructing the data processing environment of the corresponding wireless connection technology using the idle DU resources and the software,
performing a test on the constructed environment through the session, and
processing actual data through the session when the test through the session succeeds.

4. A resource management method of a communication network which is performed in an integrated base station, comprising:
monitoring traffic through wireless connection technology using allocated DU resources;
requesting allocation of idle DU resources for arbitrary wireless connection technology when traffic through the arbitrary wireless connection technology from among the wireless connection technology using the allocated DU resources is an allocation reference or larger based on the result of the monitoring;
receiving, from a resource management apparatus, an idle DU resource list in response to the request for the allocation of the idle DU resources;
receiving, from the resource management apparatus, software associated with the arbitrary wireless connection technology to use the idle DU resources included in the idle DU resource list; and
constructing a data processing environment of corresponding wireless connection technology using the idle DU resources included in the idle DU resource list and the software, and processing data through the constructed data processing environment.

5. The resource management method of claim 4, wherein receiving the software includes receiving, from the resource management apparatus, the software associated with the arbitrary wireless connection technology to use the idle DU resources included in the idle DU resource list when the idle DU resources included in the idle DU resource list received from the resource management apparatus are available.

6. The resource management method of claim 4, wherein constructing and processing includes
setting a session by constructing the data processing environment of the corresponding wireless connection technology using the idle DU resources and the software,
performing a test on the constructed environment through the session, and
processing actual data through the session when the test through the session succeeds.

7. The resource management method of claim 4, further comprising:
requesting the return of the allocated DU resources for the arbitrary wireless connection technology when the traffic through the arbitrary wireless connection technology from among the wireless connection technology using the allocated DU resources is a return standard or less as determined from the monitoring;
receiving, from the resource management apparatus, a return DU resource list in response to the request for the return of the allocated DU resources; and
returning, to the resource management apparatus, return DU resources by deleting corresponding software from the return DU resources included in the return DU resource list.

8. The resource management method of claim 7, wherein returning includes
determining whether processing of data is performed through the return DU resources included in the return DU resource list;
moving the data processed through the return DU resources included in the return DU resource list so as to enable the data to be processed through other DU resources in the same integrated base station so that the processing of data is not performed through the return DU resources included in the return DU resource list, when the processing of data is determined to be performed through the return DU resources included in the return DU resource list;
deleting software installed in the return DU resources included in the return DU resource list; and
notifying the resource management apparatus that a return process of the return DU resources included in the return DU resource list is completed.

9. A resource management method of a communication network, which is performed in a resource management apparatus, comprising:
receiving DU resource information from at least one integrated base station, and dynamically managing a state of the use of a DU resource a basis of the DU resource information;
receiving a request for allocation of idle DU resources from an arbitrary integrated base station from among the at least one integrated base station;
generating an idle DU resource list by designating the idle DU resources based on an allocation reference of the DU resources according to traffic performance for each wireless connection technology in response to the request for the allocation of the idle DU resources, and providing the generated idle DU resource list to the arbitrary integrated base station; and
providing corresponding software to the arbitrary integrated base station in response to a request for provision of software associated with the wireless connection technology to be used in the idle DU resources included in the idle DU resource list.

10. The resource management method of claim 9, further comprising:
receiving a request for return of the allocated DU resources from the arbitrary integrated base station among the at least one integrated base station; and
generating a return DU resource list using DU resources required for currently processing traffic in the arbitrary integrated base station and the DU resources allocated to the arbitrary integrated base station in response to the request for the return of the allocated DU resources, and providing the generated return DU resource list to the arbitrary integrated base station.
